(19) United States
(12) Patent Application Publication
(10) Pub. No.: US 2023/0229246 A1
(43) Pub. Date: Jul. 20, 2023

(54) OPTIMIZATION ON AN INPUT SENSOR BASED ON SENSOR DATA

(71) Applicant: Apple Inc., Cupertino, CA (US)

(72) Inventors: Holly Gerhard, Cupertino, CA (US); Grant H. Mulliken, Los Gatos, CA (US); Ian M. Bullock, Cupertino, CA (US); Jae Hyun Cho, Campbell, CA (US); John A. Porcella, Campbell, CA (US); Kyle J. Nekimken, San Jose, CA (US)

(21) Appl. No.: 18/096,759

(22) Filed: Jan. 13, 2023

Related U.S. Application Data
(60) Provisional application No. 63/299,489, filed on Jan. 14, 2022.

(51) Int. Cl. G06F 3/023; G06F 3/04845

(52) U.S. Cl. CPC G06F 3/0238; G06F 3/04845

(57) ABSTRACT

Various implementations disclosed herein include devices, systems, and methods that determine whether to provide a response based on the characteristic associated with the use of an input sensor (e.g., a keyboard). For example, an example process may include obtaining sensor data from a first sensor of the one or more other sensors, wherein the first sensor is separate from the input sensor, and the sensor data is associated with use of the input sensor by a user, assessing a characteristic associated with the use of the input sensor based on the sensor data, and determining whether to provide a response based on the characteristic associated with the use of the input sensor, the response updating the input sensor with a personalized setting or providing personalized content (e.g., feedback or autocomplete) to the user regarding input sensor use.

### CROSS-REFERENCE TO RELATED APPLICATIONS

This application claims the benefit of U.S. Provisional Application Ser. No. 63/299,489 filed Jan. 14, 2022, which is incorporated herein in its entirety.

### TECHNICAL FIELD

The present disclosure generally relates to systems, methods, and devices that provide a response or action based on a characteristic associated with the use of an input sensor.

### BACKGROUND

One objective for an input sensor, such as a keyboard, is to enable input (e.g., text input) into an electronic device while minimizing the attention that the user pays to the input sensor itself. For example, the user input experience may desirably include no or less searching for keys, no or less distraction from displeasing input sensor acoustics, no sticking keys, no or less thought about how hard to press down on each key, etc. Instead, the input sensor may ideally be configured to enable the user to use his or her mental resources to provide instruction to the device without any distraction from the input sensor itself. In addition, an input sensor configuration that is well suited for one user may be ill-suited, distracting, or frustrating to use by another user. There is thus a need to provide better and more tailored user experiences associated with input sensors.

### SUMMARY

Various implementations disclosed herein include devices, systems, and methods that use data of a user's use of an input sensor and/or his or her environment to improve the user's experience with the input sensor. This may involve responding to such data by updating an input sensor with a personalized setting. It may involve responding to such data by providing personalized content such as a suggestion for the user to do something that will improve the user's experience with the input sensor. It may involve responding to such data by providing an input sensor action such as an automated input or an automated input correction. In one example, a method monitors keyboard use (including keystroke dynamics) to alter hardware or software (e.g., touchscreen) keyboard settings. In another example, a method provides notifications to a user to make adjustments (e.g., change his or her posture while typing).

Techniques described herein may personalize a user's input sensor experience based on individual use patterns, physiological data (e.g., using gaze for predictive text), cognitive state (e.g., stressed), context of the environment (e.g., typing on a bumpy train, time, ambient light, other apps, etc.), and/or user physical characteristics (e.g., size of hand, height, proper typing stance, etc.). Multiple sensors may track keystroke patterns and other keyboard use characteristics (e.g., accelerometers, microphone, cameras (eye tracking or finger tracking while typing), ambient light sensors, etc.). Information from such sensors may be used to provide a response, e.g., customizing an input sensor configuration or providing a notification that facilitates a better experience using the input sensor. An input sensor may be customized to change its appearance, layout/size, haptic feedback, audio-feedback, and the like. Additionally, the system can also learn to identify aspects of user-specific keyboard use that cause user frustration and intelligently diminish those frustrating aspects. For example, the system may learn repeated key location errors and update the layout of keys on an input sensor to align with the user's apparent mental model or inherent preferences regarding key position.

In general, one innovative aspect of the subject matter described in this specification can be embodied in methods at a device including a processor, an input sensor, and one or more other sensors, where the input sensor includes a plurality of interactable elements. The methods include the actions of obtaining sensor data from a first sensor of the one or more other sensors, wherein the first sensor is separate from the plurality of interactable elements of the input sensor, and the sensor data is associated with use of the input sensor by a user, assessing a characteristic associated with the use of the input sensor based on the sensor data, and determining whether to provide a response based on the characteristic associated with the use of the input sensor, the response updating the input sensor with a personalized setting or providing personalized content to the user regarding input sensor use.

In general, another innovative aspect of the subject matter described in this specification can be embodied in methods at a device including a processor, an input sensor, and one or more other sensors, where the input sensor includes a plurality of interactable elements. The methods include the actions of obtaining sensor data from the one or more other sensors associated with use of the input sensor by a user assessing a characteristic associated with the use of the input sensor based on the sensor data, determining whether to provide an input sensor action based on the characteristic associated with the use of the input sensor, and in response to determining to provide an input sensor action, updating an attribute associated with the input sensor.

These and other embodiments can each optionally include one or more of the following features.

In some aspects, the characteristic associated with the use of the input sensor includes a keystroke use pattern associated with the user. In some aspects, the characteristic associated with the use of the input sensor includes a physiological state.

In some aspects, the characteristic associated with the use of the input sensor includes a cognitive state. In some aspects, the characteristic associated with the use of the input sensor includes an environmental context. In some aspects, the characteristic associated with the use of the input sensor is based on content displayed on the device. In some aspects, the characteristic associated with the use of the input sensor includes physical characteristics of the user. In some aspects, obtaining sensor data includes acquiring hand pose information during use of the input sensor.

In some aspects, the method further includes determining to provide personalized content for the response based on the hand pose information associated with the use of the input sensor.

In some aspects, determining whether to provide the response based on the characteristic associated with the use of the input sensor includes determining to update the input sensor with the personalized setting.

In some aspects, the personalized setting includes repositioning at least one interactable element of the plurality of the plurality of interactable elements. In some aspects, the personalized setting includes changing an audio feedback setting of at least one interactable element of the plurality of the plurality of interactable elements. In some aspects, the personalized setting includes changing a haptic feedback setting of at least one interactable element of the plurality of the plurality of interactable elements.

In some aspects, determining whether to provide the response based on the characteristic associated with the use of the input sensor is based on determining a likelihood function associated with preference settings of the user.

In some aspects, the method further includes gradually updating the input sensor with the personalized setting based on the determined likelihood function associated with preference settings of the user.

In some aspects, providing personalized content includes providing feedback to the user regarding the assessed characteristic of the user during use of the input sensor.

In some aspects, the use of the input sensor includes text being displayed on the device, and providing personalized content includes modifying the text based on assessing the characteristic associated with the use of the input sensor.

In some aspects, assessing the characteristic associated with the use of the input sensor based on the sensor data includes determining an input sensor use pattern associated with the use of the input sensor for the user during a time period, and determining whether to provide the response based on the characteristic associated with the use of the input sensor includes updating the input sensor with the personalized setting from a first state to a different second state.

In some aspects, the input sensor use pattern is classified using a machine learning technique based on the sensor data and the characteristic associated with the use of the input sensor.

In some aspects, the machine learning technique is refined based on at least one of text input data, keystroke rate, error rate, and a force of typing.

In some aspects, the method further includes adjusting a presentation of content on the device based on determining to provide the response based on the characteristic associated with the use of the input sensor.

In some aspects, the sensor data includes image data of an eye, a hand, or a head of the user. In some aspects, the sensor data includes motion sensor data, haptic data, location data, or audio data. In some aspects, the sensor data includes physiological data. In some aspects, the physiological data includes electrocardiogram (EKG) data, electroencephalogram (EEG) data, or electrooculography (EOG) data. In some aspects, the sensor data includes ambient light data.

In some aspects, the input sensor includes a keyboard.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device presenting a visual and/or auditory experience, an input sensor that includes a plurality of interactable elements, and sensors obtaining physiological data from a user in accordance with some implementations.

FIGS. 2A-2D illustrate examples of updating an input sensor based on a characteristic associated with the use of the input sensor in accordance with some implementations.

FIG. 3 illustrates a system diagram for determining whether to provide a response based on a characteristic associated with the use of the input sensor in accordance with some implementations.

FIG. 4 is a flowchart representation of a method for determining whether to provide a response based on a characteristic associated with the use of the input sensor in accordance with some implementations.

FIG. 5 is a flowchart representation of a method for determining whether to provide an input sensor action based on the characteristic associated with the use of the input sensor in accordance with some implementations.

FIG. 6 illustrates device components of an exemplary device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

Various implementations disclosed herein include devices, systems, and methods that use data of a user's use of an input sensor and/or his or her environment to improve the user's experience with the input sensor. This may involve responding to such data by updating an input sensor with a personalized setting. It may involve responding to such data by providing personalized content such as a suggestion for the user to do something that will improve the user's experience with the input sensor. It may involve responding to such data by providing an input sensor action such as an automated input or an automated input correction. In one example, a method monitors keyboard use (including keystroke dynamics) to alter hardware or software (e.g., touchscreen) keyboard settings. In another example, a method provides notifications to a user to make adjustments (e.g., change his or her posture while typing).

The processes can personalize a user's input sensor experience based on individual use patterns, physiological data (e.g., using gaze for predictive text), cognitive state (e.g., stressed), context of the environment (e.g., typing on a bumpy train, time, ambient light, other apps, etc.), and/or user physical characteristics (e.g., size of hand, height, proper typing stance). Multiple sensors may track keystroke patterns and other keyboard use characteristics (e.g., accelerometers, microphone, cameras (eye tracking or finger tracking while typing), ambient light sensors, etc.). Information from such sensors may be used to provide a response, e.g., customizing an input sensor configuration or providing a notification that facilitates a better experience using the input sensor. An input sensor may be customized to change its appearance, layout/size, haptic feedback, audio-feedback, and the like. Additionally, the system can also learn to identify aspects of user-specific keyboard use that cause user frustration and intelligently diminish those frustrating aspects. For example, the system may learn repeated key location errors and update the layout of keys on an input sensor to align with the user's apparent mental model of key position.

An example of an input sensor action is updating settings for a virtual keyboard such as it is presented to a user (e.g., on a touchscreen device/display), or other settings such as haptics, sensitivity, and illumination settings. In some implementations, monitoring use characteristics of the input sensor can be applied to a hardware input sensor (e.g., a physical keyboard) for monitoring user sensor data, text entry data characteristics, and the user environment. Monitoring such information for a hardware input sensor, notifications may be provided to the user, e.g., providing particular feedback to improve the input sensor experience. For example, some notifications could include suggestions for the user to correct his or her posture while typing, identify typical errors occurring during typing based on keypress forces, or present other characteristics and feedback to the user based on the assessment of data collected.

In some implementations, algorithms and/or machine learning models may be configured/refined based on (e.g., learning from) characteristics associated with use of an input sensor. For example, the use characteristics may include a keyboard use pattern (e.g., keystroke dynamics, keystroke rate, error rate, force of typing, and the like). Additionally, characteristics associated with the use of an input sensor may further include determining a physiological state (e.g., gaze direction, head position) or cognitive state (e.g., stressed, attentive, attentive to a particular thing, responding negatively to a keyboard error) of the user. Moreover, environmental context, displayed content, and/or user physical characteristics (e.g., motor impairments, user's anatomy, i.e., broken/missing finger, small hands, etc.) may also be analyzed characteristics associated with use of the input sensor.

Physiological data may be used to determine whether to provide a response based on the characteristic associated with the use of the input sensor. For example, the user's gaze may move in a way that corresponds to typing or may correspond to a particular behavioral or cognitive state. One cognitive state that may be determined that is associated with the use of the input sensor may be detecting frustration by the user while typing. For example, the techniques described herein may detect that user is frustrated because he or she tends to type the same error (e.g., typing “teh” constantly instead of “the”). Or the system can detect from the user's eye gaze that he or she is constantly looking away from content being displayed on the device (e.g., at a coffee shop and is frequently distracted). Additionally, the user's eye characteristics may be analyzed to determine that the user's gaze movement corresponds to an average typing pace or a typing pace that is associated with the specific user. Additionally, determining the user's use characteristics may involve obtaining images of the eye or electrooculography (EOG) data, sensor data corresponding to micro saccades, and/or sensor data corresponding to head movements, from which pupil response/gaze, direction/movement or other user characteristics can be determined.

Context may additionally be used to assess a characteristic associated with the use of the input sensor. For example, a scene analysis of an experience can determine a scene understanding of the visual and/or auditory attributes associated with content being presented to the user (e.g., what is being presented in content while the user is typing text). Additionally, attributes associated with the environment of the user (e.g., where is the user, what is the user doing, what objects are nearby) may be analyzed. For example, techniques described herein can determine that the user is trying to type on a bumpy train or detect the user in a loud setting. Attributes of both the presented content and environment of the user can improve the determination of whether to provide a response (e.g., an input sensor configuration update or a suggestion for the user to do something to improve the experience of using the input sensor). The system may update context aware settings automatically, for example, by silencing in quiet zones, providing more haptics in bumpy zones (e.g., on a train), providing diminished graphics for entertainment, and the like.

In some implementations, determining whether to provide a response associated with updating an input sensor with a personalized setting or providing personalized content, or whether to provide an input sensor action based on a characteristic associated with the use of an input sensor may be based on a characteristic of an environment of the user (e.g., real-world physical environment, a virtual environment, or a combination of each). The device (e.g., a handheld, laptop, desktop, or head-mounted device (HMD)) provides an experience (e.g., a visual and/or auditory experience) of the real-world physical environment or an extended reality (XR) environment. The device obtains, with one or more sensors, physiological data (e.g., electroencephalography (EEG) amplitude, pupil modulation, eye gaze saccades, head movements measured by an inertial measurement unit (IMU), etc.) associated with the user. Based on the obtained physiological data, the techniques described herein can determine whether to provide a response based on the characteristic associated with the use of the input sensor. For example, the techniques can update the input sensor with a personalized setting or provide personalized content (e.g., feedback notifications, autocomplete for particular text, and the like) to the user regarding input sensor use, and adjust the content corresponding to the experience.

Physiological data, such as EEG amplitude/frequency, sensor data corresponding to pupil modulation, sensor data corresponding to eye gaze saccades, etc., can depend on the individual, characteristics of the scene in front of him or her (e.g., video content), and attributes of the physical environment surrounding the user including the activity/movement of the user. Physiological data can be obtained while using a device with eye tracking technology (and other physiologic sensors) while users perform tasks. In some implementations, physiological data can be obtained using other sensors, such as EEG sensors or EDA sensors. Observing repeated measures of physiological data to an experience can give insights about a characteristic associated with the use of the input sensor of the user.

In some implementations, personalization of the input sensor may be improved (e.g., updating settings to better match the user's needs) based on individual keyboard use patterns, physiological data (e.g., using gaze for predictive text), cognitive state (e.g., stressed), context of the environment (e.g., typing on a bumpy train, time, ambient light, other apps, etc.), and/or user physical characteristics (e.g., size of hand, height, proper typing stance) by incorporating practice exercises. For example, a machine learning algorithm may be implemented to determine whether or not a user's keystroke dynamics (e.g., determining whether the user is typing, determining a typing pace, and other keystroke dynamics) means that he or she may prefer different attributes associated with the keyboard. For example, the system may change the keyboard appearance, layout/size, haptic feedback, audio-feedback, and the like.

In some implementations, personalized settings of the input sensor may vary by context, such that one user has a suite of settings that lead to optimal text input in various scenarios. For example, these settings may vary by time of day, type of application, location (e.g., home vs. office), or a level of immersion in a virtual environment (from reality, augmented reality, virtual reality, etc.). A user's keyboard setting suite could be associated with their user ID and/or stored within device, and the input sensor could be generic until a user authenticates and/or a context is determined, at which point, the appropriate settings may be enabled from the user's setting suite based on context. In such an implementation, the user's settings follow them. A user may be enabled to travel to different environments without the need of their own keyboard and still be enabled to use keyboard features that are customized to their own preferences and/or otherwise are tailored to specifically enhance the user's input sensor experience.

The optimal settings learning process could proceed in a subtle, adaptive manner, such that very small excursions across the space of possible settings (e.g., possible keyboard key positions) are made smoothly over time, and the user does not experience abrupt transitions in the feel and sound of the keyboard. If an excursion in one direction of settings space begins to indicate poorer user experience, that excursion could be dialed back and another direction could be explored. This could be repeated for various directions in the settings space until settings that correspond to positive user experience are identified (potentially for each context/use case). The exploration of possible settings could proceed from an initial model trained on a large dataset of diverse users in different contexts, such that best guesses for optimal settings are selected first, to minimize chances of the user perceiving keyboard settings that lead to a poor text input experience. Another approach to making best guesses for optimal settings would be to utilize any knowledge of other keyboards the user frequently uses based on the assumption that familiarity often drives keyboard preference.

Some implementations assess physiological data and other user information to help improve a user experience. In such processes, user preferences and privacy should be respected, as examples, by ensuring the user understands and consents to the use of user data, understands what types of user data are used, has control over the collection and use of user data and limiting distribution of user data, for example, by ensuring that user data is processed locally on the user's device. Users should have the option to opt in or out with respect to whether their user data is obtained or used or to otherwise turn on and off any features that obtain or use user information. Moreover, each user should have the ability to access and otherwise find out anything that the system has collected or determined about him or her.

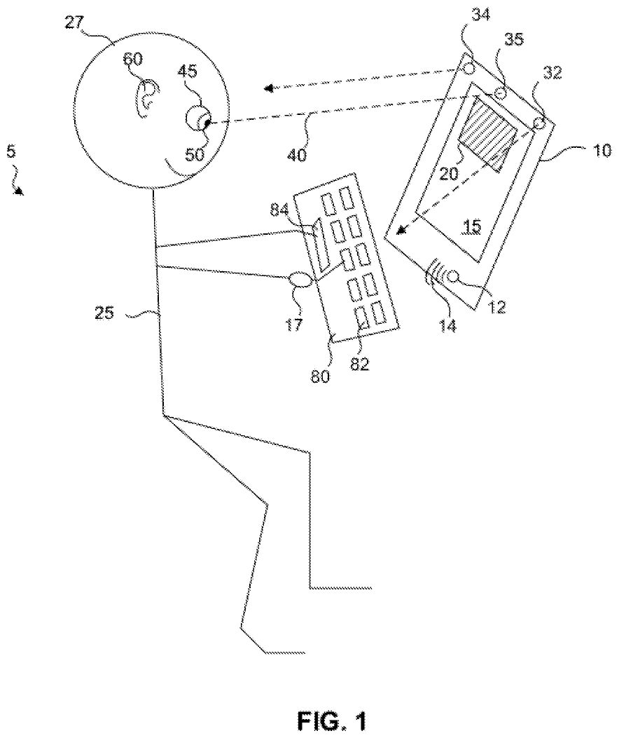

FIG. 1 illustrates a real-world environment 5 including a device 10 with a display 15, an input sensor 80 (e.g., a keyboard) with selectable elements 82, 84, and the like (e.g., keyboard keys). In the example environment 5, the user 25 is illustrated in a sitting (e.g., typing) position. The user 25 may be sitting in a chair at a desk, sitting on train, or any other physical environment where the user is interacting with input sensor 80 and device 10 (e.g., typing).

In some implementations, the device 10 displays content 20 to a user 25. For example, content 20 may be a button, a user interface icon, a text box, a graphic, etc. In some implementations, the input sensor 80 is a hardware device, such a as a physical keyboard. In an exemplary implementation, the input sensor 80 is a virtual keyboard that is presented on the display 15 of device 10 (e.g., a keyboard presented on a touch screen device such as a mobile phone or tablet). For example, the display may provide of a view 3D environment with a virtual keyboard displayed at a 3D position. The device 10 may enable the user to interact with the virtual keyboard, for example, by moving his or her hands in that 3D space, e.g., to virtually contact a virtual key of the virtual keyboard. Alternatively, in some implementations, a virtual keyboard could be displayed on a separate display panel to mimic a hardware keyboard. For example, an interactive display panel could be used to display a virtual keyboard on a separate device, or attached to the device 10 such as a laptop (e.g., replace the keyboard with an interactive display panel to show a virtual keyboard).

The phrase “virtual keyboard” as used herein refers to any type of input sensor having one or more aspects provided via a display and that provides individual input mechanisms (e.g., keys) that can be activated individually and/or in combination with one another by a user to initiate one or more inputs. One example of a virtual keyboard is a keyboard displayed on a display to appear at a 3D position in the air or on a surface in a physical space where interactions with the virtual keyboard are determined based on detecting an interaction with those that 3D position in the physical space. Another example of a virtual keyboard is a keyboard that is displayed on a touchscreen display where interactions with the touchscreen trigger the inputs associated with keys displayed at the touched locations on the touchscreen. Another example of a virtual keyboard is a keyboard that is projected via a light projector to appear on a surface (e.g., a table top) in a physical environment where interactions with the surface are detected and used to trigger inputs associated with keys projected onto the touched locations on the surface.

In some implementations, content 20 may be a visual experience (e.g., an education experience). As used herein, the phrase “experience” refers to a period of time during which a user uses an electronic device and has one or more interaction events. In one example, a user has an experience in which the user perceives a real-world environment, virtual content, or both, while holding, wearing, or being proximate to an electronic device that includes one or more sensors that obtain physiological data that is indicative of the user's interaction event. In another example, a user has an experience in which the user perceives content displayed by an electronic device while the same or another electronic device obtains physiological data (e.g., pupil data, EEG data, head movements, etc.) to assess the user's interaction with content 20 (e.g., typing on the input sensor 80 via selectable elements 82, 84, etc.).

The physiological data may include, but is not limited to, pupil data, EEG data, head movement data, gaze speed, blink rate, raw eye images, eye-lid shape, micro saccades, eye tremor, eye drift, heart rate, and the like. In another example, a user has an experience in which the user holds, wears, or is proximate to an electronic device that provides a series of audible or visual instructions that guide the experience. For example, the instructions may instruct the user to have particular actions during particular time segments of the experience, e.g., instructing the user to focus on his or her posture while typing on the input sensor 80 in order to further train a machine learning algorithm to better detect the user a characteristic associated with the use of the input sensor 80. During such an experience, the same or another electronic device (e.g., sensor 17) may obtain physiological data to assess the user's 25 characteristic(s) associated with the use of the input sensor 80.

In some implementations, the content 20 may include a feedback mechanism for the user that is specific to the experience (e.g., a visual or audio cue to focus on a particular task during an experience, such as posture while typing, or suggesting changing the layout or other keyboard settings of the input sensor 80). In some implementations, the visual experience (e.g., content 20) can occupy the entire display area of display 15. For example, during an experience, content 20 may be a video or sequence of images that may include visual and/or audio cues presented to the user. Other visual experiences that can be displayed for content 20 will be further discussed herein.

The device 10 obtains physiological data (e.g., EEG amplitude/frequency, pupil modulation, eye gaze saccades, etc.) from the user 25 via a sensor 35 (e.g., one or more camera's facing the user to capture light intensity data and/or depth data of a user's facial features, head movements, and/or eye gaze). For example, the device 10 obtains pupillary data 40 (e.g., eye gaze characteristic data) via sensor 35. In some implementations, head and or body movements of the user 25 may be obtained by sensor(s) 32, 34 as illustrated (e.g., camera's facing the user 25). Alternatively, head movements and/or body movements may be obtained by another sensor that the user 25 is wearing (e.g., sensor 17). If the device 10 is worn on the head (e.g., an HMD), then the head movements of the user 25 may be determined by an IMU, or another type of accelerometer sensor.

In some implementations, the device 10 includes an eye tracking system for detecting eye position and eye movements. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 25. Moreover, the illumination source of the device 10 may emit NIR light to illuminate the eyes of the user 25 and the NIR camera may capture images of the eyes of the user 25. In some implementations, images captured by the eye tracking system may be analyzed to detect position and movements of the eyes of the user 25, or to detect other information about the eyes such as pupil dilation or pupil diameter. Moreover, the point of gaze estimated from the eye tracking images may enable gaze-based interaction with content shown on the near-eye display of the device 10.

In some implementations, the device 10 has a graphical user interface (GUI), one or more processors, memory and one or more modules, programs or sets of instructions stored in the memory for performing multiple functions. In some implementations, the user 25 interacts with the GUI through finger contacts and gestures on the touch-sensitive surface (e.g., via input sensor 80). In some implementations, the functions include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In some implementations, the device 10 employs various physiological sensor, detection, or measurement systems. Detected physiological data may include, but is not limited to, EEG, electrocardiography (ECG), electromyography (EMG), functional near infrared spectroscopy signal (fNIRS), blood pressure, skin conductance, or pupillary response. The device 10 maybe communicatively coupled to an additional sensor. For example, an external sensor (e.g., an EDA sensor) maybe communicatively coupled to device 10 via a wired or wireless connection, and the external sensor may be located on the skin of the user 25 (e.g., on the user's arm, or placed on the hand/fingers of the user). For example, the sensor can be utilized for detecting EDA (e.g., skin conductance), heart rate, or other physiological data that utilizes contact with the skin of a user. Moreover, the device 10 (using one or more sensors) may simultaneously detect multiple forms of physiological data in order to benefit from synchronous acquisition of physiological data. Moreover, in some implementations, the physiological data represents involuntary data, e.g., responses that are not under conscious control. For example, a pupillary response may represent an involuntary movement.

In some implementations, one or both eyes 45 of the user 25, including one or both pupils 50 of the user 25 present physiological data in the form of a pupillary response (e.g., pupillary data 40). The pupillary response of the user 25 results in a varying of the size or diameter of the pupil 50, via the optic and oculomotor cranial nerve. For example, the pupillary response may include a constriction response (miosis), e.g., a narrowing of the pupil, or a dilation response (mydriasis), e.g., a widening of the pupil. In some implementations, the device 10 may detect patterns of physiological data representing a time-varying pupil diameter.

In some implementations, a pupillary response may be in response to an auditory feedback that one or both ears 60 of the user 25 detect (e.g., an audio notification to the user). For example, device 10 may include a speaker 12 that projects sound via sound waves 14. The device 10 may include other audio sources such as a headphone jack for headphones, a wireless connection to an external speaker, and the like.

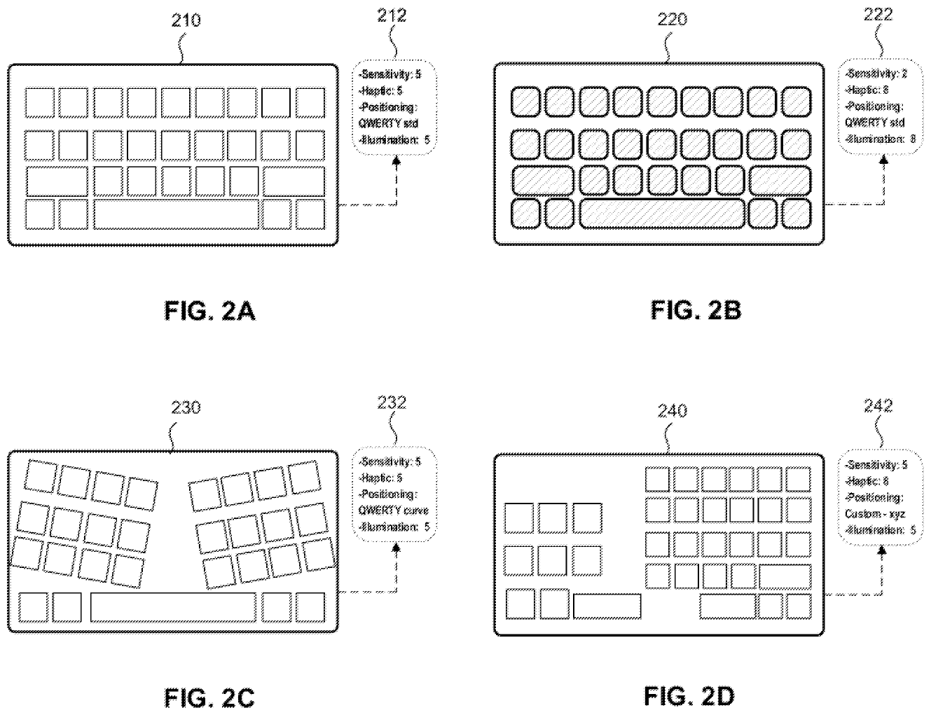

FIGS. 2A-2D illustrate different examples of updating an input sensor (e.g., input sensor 80 of FIG. 1) based on a characteristic associated with the use of the input sensor in accordance with some implementations. In particular, FIGS. 2A-2D illustrate virtual keyboards 210, 220, 230, and 240, respectively, that each have different keyboard settings.

FIG. 2A illustrates virtual keyboard 210 with keyboard settings 212. In particular, virtual keyboard 210 represents a standard QWERTY keyboard layout with “default” settings as an example. For example, keyboard settings 212 show sensitivity at level 5 (e.g., middle of scale 1-10), haptics at level 5 (e.g., middle of scale 1-10), positioning as “QWERTY std” (e.g., standard QWERTY keyboard), and illumination at level 5 (e.g., middle of scale 1-10). Sensitivity settings refer to how sensitive each interactive element (e.g., key) is in being triggered in relation to keypress force by a user. Haptic settings refer to the level of haptic feedback (e.g., vibrations) that may be provided to the user after each selection of an interactable element. Illumination settings refer to the level of illumination that is provided to the interactable elements of the keyboard, or additionally, and/or alternatively, illumination to the area around the interactable elements.

FIG. 2B illustrates virtual keyboard 220 with keyboard settings 222. In particular, virtual keyboard 220 represents a standard QWERTY keyboard layout similar to keyboard 210, but with different settings. For example, keyboard settings 222 show sensitivity at level 2, haptics at level 8, positioning as “QWERTY std” (e.g., standard QWERTY keyboard), and illumination at level 8 (e.g., higher end of scale 1-10). In particular, keyboard 220 is illustrated to display a higher illumination of each selectable element as compared to keyboard 210. For example, if a user is sitting in a moving train, and an ambient light sensor detects a darker environment and another sensor detects the motion (e.g., via GPS and/or an accelerometer), the techniques described herein can adjust the keyboard settings appropriately. In this example, the illumination level is increased so a user can better see the keys of keyboard 220. Additionally, the haptic level is increased to level 8 to provide additional vibrations to the user while typing and the sensitive level is decrease to level 2 to avoid less errors of the user accidently touching an unintended key. For example, if a user is trying to type while on a bumpy train ride, the techniques described herein can automatically detect the environment of the user, and possibly the frustration of the user while trying to type, and update the settings accordingly (e.g., less sensitive, more haptic feedback, more illumination of the keys).

FIG. 2C illustrates virtual keyboard 230 with keyboard settings 232. In particular, virtual keyboard 230 represents a standard QWERTY keyboard layout similar to keyboard 210, but with a different location of some or most of the keys for ergonomic purposes. For example, keyboard settings 232 show the sensitivity at level 5, haptics at level 5, positioning as “QWERTY curve” (e.g., standard QWERTY keyboard with a split/curve configuration), and illumination at level 5. In particular, keyboard 230 is illustrated to display the layout can be changed as to the location of the keys as compared to keyboard 210, but still be in a standard QWERTY format. For example, the layout of a curved and split QWERTY keyboard may be recommended by the system described herein if the sensor data analysis shows that the user may benefit from the updated layout. For example, sensor data such as image data of the user's fingers as he or she types, or the height of the user's hand above the keyboard determined by a sensor the user wears (e.g., a digital watch, such as sensor 17 as illustrated in FIG. 1) may indicate the user could develop carpal tunnel syndrome or other issues related to the positioning of the user's hands as he or she types.

FIG. 2D illustrates virtual keyboard 240 with keyboard settings 242. In particular, virtual keyboard 240 represents a customized keyboard layout with different locations of some or most of the keys for detected physical limitation purposes. For example, keyboard settings 242 show sensitivity at level 5, haptics at level 8, positioning as “Custom—xyz” (e.g., custom configuration), and illumination at level 5. In particular, keyboard 240 is illustrated to show that the layout can be changed as to the location of the keys as compared to keyboard 210. For example, sensor data such as image data of the user's fingers may indicate the user is missing some fingers on his or her left hand, thus the layout of keyboard 240 is adjusted to have less keys for the user to utilize on the left side, and more keys to interact with for the right hand. In some implementations, user data is continuously collected as the user interacts with the keyboard 240 such that the techniques described herein may suggest additional different layouts for the particular user that is missing fingers. The additional layouts may be analyzed by the system until a layout is either selected by the user or the system that produces the least amount of user discomfort and/or reduces the amount of typing errors. For example, each key on the keyboard may be individually changed in location, and additionally updated in either sensitivity, haptic, or illumination levels.

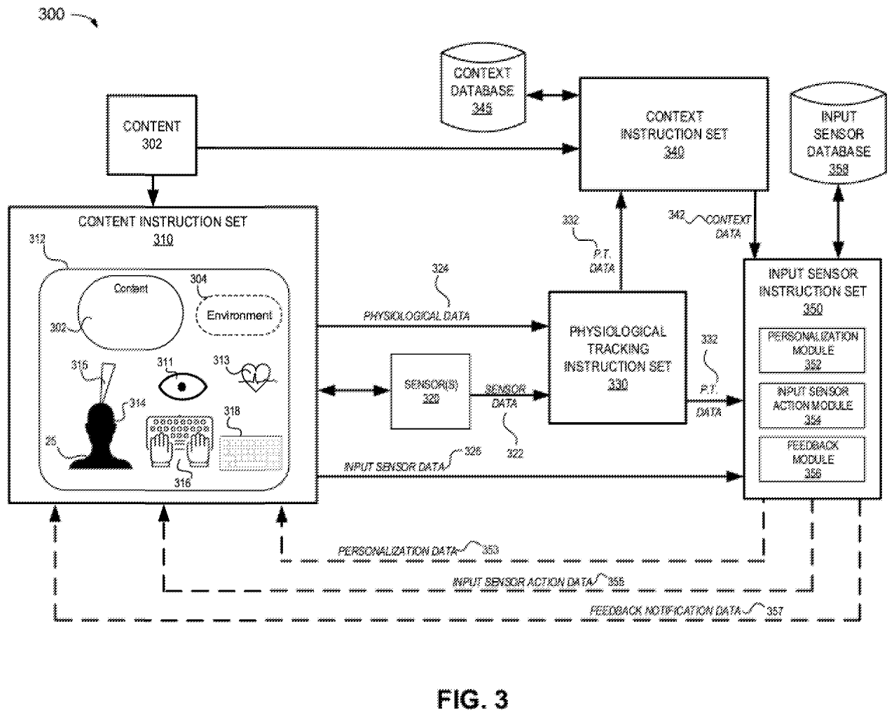

FIG. 3 is a system flow diagram of an example environment 300 in which an input sensor assessment system can determine whether to provide a response based on a characteristic associated with the use of the input sensor according to some implementations. In some implementations, the system flow of the example environment 300 is performed on a device (e.g., device 10 of FIG. 1), such as a mobile device, desktop, laptop, or server device. The content of the example environment 300 can be displayed on a device (e.g., device 10 of FIG. 1) that has a screen (e.g., display 15) for displaying images and/or a screen for viewing stereoscopic images such as an HMD. In some implementations, the system flow of the example environment 300 is performed on processing logic, including hardware, firmware, software, or a combination thereof. In some implementations, the system flow of the example environment 300 is performed on a processor executing code stored in a non-transitory computer-readable medium (e.g., a memory).

The system flow of the example environment 300 acquires and presents content (e.g., text, or an image/video that includes at least a portion that a user can input text) to user 25, analyzes the text data 318 (e.g., input sensor data 326) as the user 25 interacts (e.g., types) on the input sensor (e.g., input sensor 80), analyzes the content and/or the environment for context data, obtains physiological data associated with the user while using the input sensor, assesses a characteristic associated with the use of the input sensor, and determines whether to provide a response based on the assessment of the characteristic (e.g., update the keyboard settings, provide a notification to the user, etc.). For example, an input sensor assessment technique described herein determines whether to provide a response for updating an input sensor with a personalized setting or providing personalized content, or whether to provide an input sensor action based on a characteristic associated with the use of an input sensor (e.g., a keyboard). For example, a method may include monitoring keyboard use (including keystroke dynamics) to alter hardware keyboard or software (touchscreen) keyboard settings and/or provide notifications to the user to make adjustments (e.g., change his or her posture while typing). The processes can personalize the experience based on individual use patterns, physiological data (e.g., using gaze for predictive text), cognitive state (e.g., stressed), context of the environment (e.g., typing on a bumpy train, time, ambient light, other apps, etc.), and/or user physical characteristics (e.g., size of hand, height, proper typing stance). The input sensor can change appearance, layout/size, haptic feedback, audio-feedback, and the like. Multiple sensors may track keystroke patterns and other keyboard use characteristics (e.g., accelerometers, microphone, cameras (eye tracking or finger tracking while typing), ambient light sensors, etc.). Additionally, the system can also learn to identify user-specific keyboard pain points and intelligently diminish them. For example, in some implementations, the system can intelligently predict error-correction delete key usage and automatically perform the particular predicted keystrokes. Similarly, the system could learn repeated key location errors and update the layout to align with the user's internal model of key position.

The example environment 300 includes a content instruction set 310 that is configured with instructions executable by a processor to provide and/or track content 302 for display on a device (e.g., device 10 of FIG. 1). For example, the content instruction set 310 provides content presentation instant 312 that includes content 302 to a user 25 while user is within a physical environment 304 (e.g., a room, outside, etc.). For example, content 302 may include a word processing application for a user to input text as well as images and or sounds (e.g., a video). The content presentation instant 312 could be an XR experience that includes some virtual content and some images or views of a physical environment. Alternatively, the user could be wearing an HMD and is looking at a real physical environment either via a live camera view, or the HMD allows a user to look through the display, such as wearing smart glasses that user can see through, but still be presented with visual and/or audio cues, and the input sensor (e.g., a keyboard) is displayed virtually on a surface of an object (e.g., a table).

During an experience, while a user 25 is viewing the content 302 and entering text on an input sensor, input sensor keystroke data 318 is collected and sent as input sensor data 326. Additionally, in some implementations, hand pose information 316 is obtained and sent as input sensor data 326. In some implementations, eye gaze data 315 and pupillary data 311 (e.g., pupillary data 40 such as eye gaze characteristic data) of the user's eyes can be monitored and sent as physiological data 324. Additionally, other physiological data can be monitored and sent as physiological data 324 such as heart rate data 313 and head movement data 314 obtained from an IMU or image data.

The environment 300 further includes a physiological tracking instruction set 330 to track a user's physiological attributes as physiological tracking data 332 using one or more of the techniques discussed herein or as otherwise may be appropriate. For example, the physiological tracking instruction set 330 may acquire physiological data 324 (e.g., pupillary data 315, cardiac data 313, and the like) from the user 25 viewing the content 302. Additionally, or alternatively, a user 25 may be wearing a sensor 320 (e.g., such as an EEG sensor, an EDA sensor, heart rate sensor, etc.) that generates sensor data 322 (e.g., IMU or pose data, EEG data, EDA data, heart rate data, and the like) as additional physiological data. Thus, as the content 302 is presented to the user as content presentation instant 312, the physiological data 324 (e.g., pupillary data 315) and/or sensor data 322 is sent to the physiological tracking instruction set 330 to track a user's physiological attributes as physiological tracking data 332, using one or more of the techniques discussed herein or as otherwise may be appropriate.

In an example implementation, the environment 300 further includes a context instruction set 340 that is configured with instructions executable by a processor to obtain the experience data presented to the user (e.g., content 302) and other sensor data (e.g., image data of the environment 304, the user's 25 face and/or eye's, etc.), and generate context data 342 (e.g., identifying people, objects, etc. of the content 302 and the environment 304). For example, the context instruction set 340 acquires content 302 and sensor data 322 (e.g., image data) from the sensor 320 (e.g., an RGB camera, a depth camera, etc.) and determines context data 342 based on identifying areas of the content while the user is viewing and/or interacting (e.g., entering text) during the presentation of the content 302 (e.g., a word processing application). Alternatively, the context instruction set 340 selects context data associated with content 302 from a context database 345 (e.g., if the content 302 was previously analyzed by the context instruction set, e.g., a previously viewed/analyzed video). In some implementations, the context instruction set 340 generates a scene understanding associated with content 302 and/or environment 304 as the context data 342. For example, the scene understanding can be utilized to track the overall context of what the user may be focused on during the presentation of content 302 (e.g., on a bumpy train), or where the user is, what the user is doing, what physical objects or people are in the vicinity of the user with respect to the environment 304.

In an example implementation, the environment 300 further includes an input sensor instruction set 350 that is configured with instructions executable by a processor to determine whether to provide a response for updating an input sensor with a personalized setting or providing personalized content, or whether to provide an input sensor action based on a characteristic associated with the use of an input sensor using one or more of the techniques discussed herein or as otherwise may be appropriate. For example, a method may include monitoring keyboard use (including keystroke dynamics) to alter hardware keyboard or software (touchscreen) keyboard settings and/or provide notifications to the user to make adjustments (e.g., change his or her posture while typing). The processes can personalize the experience based on individual use patterns, physiological data (e.g., using gaze for predictive text), cognitive state (e.g., stressed), context of the environment (e.g., typing on a bumpy train, time, ambient light, other apps, etc.), and/or user physical characteristics (e.g., size of hand, height, proper typing stance). The input sensor can change appearance, layout/size, haptic feedback, audio-feedback, and the like. Multiple sensors may track keystroke patterns and other keyboard use characteristics (e.g., accelerometers, microphone, cameras (eye tracking or finger tracking while typing), ambient light sensors, etc.). In particular, the input sensor instruction set 350 acquires input sensor data 326 from an input sensor (e.g., input sensor 180) or sensors monitoring the input sensor, and physiological tracking data 332 from the physiological tracking instruction set 330 and determines whether to provide a response or an input sensor action (e.g., update settings) during the presentation of (and interaction with) the content 302 (e.g., typing text in an application). In some implementations, the input sensor instruction set 350, via the personalization module 352, can then provide personalization data 353 (e.g., feedback notifications, autocomplete for particular text, and the like) to the content instruction set 310 based on the input sensor assessment. In some implementations, the input sensor instruction set 350, via the input sensor action module 354, can then provide input sensor action data 355 (e.g., change appearance, layout/size, haptic feedback, audio-feedback, and the like) to the input sensor based on the input sensor assessment. In some implementations, the input sensor instruction set 350, via the feedback module 356, can then provide feedback notification data 357 (e.g., visual and/or auditory notification(s) that teach the user to adjust their hand pose and/or sitting pose while typing, and the like) to the input sensor based on the input sensor assessment.

In some implementations, characteristics associated with the use of the input sensor may be specific to the user via an input sensor profile (e.g., keyboard settings profile). For example, a user profile associated with an input sensor may be stored and/or updated by the input sensor instruction set 350 via the input sensor database 358 that is specific to the user. Alternatively, in some implementations, the characteristic associated with the use of the input sensor maybe an average of any type of user (e.g., default settings), or may be an average of a user that is similar to the current user (e.g., similar height, size of hands, etc. The input sensor database 358 can also store personalization information for each input sensor setting that is updated and the context associated with each setting.

In some implementations, the input sensor instruction set 350 also acquires context data 342 from the context instruction set 340 (e.g., scene understanding data) with the physiological tracking data 332 to whether to provide a response for updating an input sensor with a personalized setting or providing personalized content, or whether to provide an input sensor action based on a characteristic associated with the use of an input sensor during the presentation of or interaction with the content 302. For example, the context data 342 may provide a scene analysis that can be used by the input sensor instruction set 350 to understand what the person is looking at, where they are at, etc., and improve the settings of the input sensor to better fit the needs of the user.

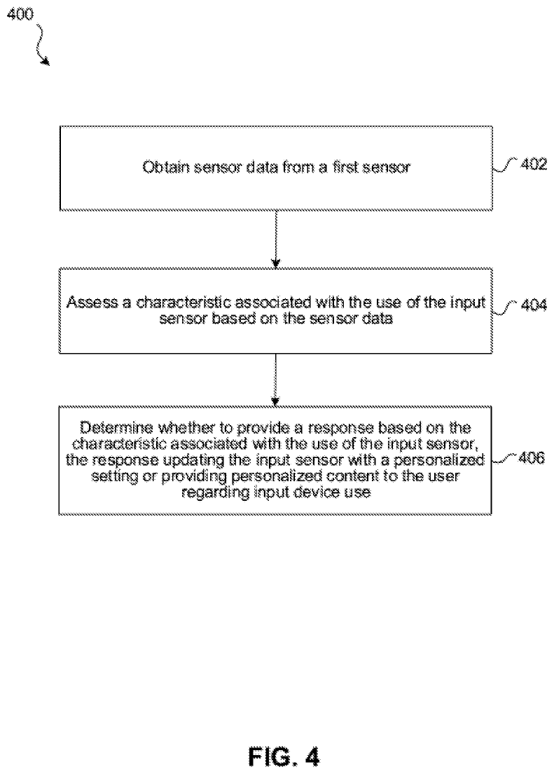

FIG. 4 is a flowchart illustrating an exemplary method 400. In some implementations, a device, such as device 10 of FIG. 1, performs the techniques of method 400 to determine whether to provide a response based on a characteristic associated with the use of an input sensor such as input sensor 80. For example, the method 400 may monitor keyboard use (including keystroke dynamics) to alter hardware keyboard or software (touchscreen) keyboard settings and/or provide notifications to the user to make adjustments (e.g., change his or her posture while typing). The processes can personalize the experience based on individual use patterns, physiological data (e.g., using gaze for predictive text), cognitive state (e.g., stressed), context of the environment (e.g., typing on a bumpy train, time, ambient light, other apps, etc.), and/or user physical characteristics (e.g., size of hand, height, proper typing stance). The input sensor can change appearance, layout/size, haptic feedback, audio-feedback, and the like. Multiple sensors may track keystroke patterns and other keyboard use characteristics (e.g., accelerometers, microphone, cameras (eye tracking or finger tracking while typing), ambient light sensors, etc.). Additionally, the system can also learn to identify user-specific keyboard pain points and intelligently diminish them. For example, in some implementations, the system can intelligently predict error-correction delete key usage and automatically perform the particular predicted keystrokes. Similarly, the system could learn repeated key location errors and update the layout to align with the user's internal model of key position.

In some implementations, the techniques of method 400 are performed on a mobile device, desktop, laptop, HMD, or server device. In some implementations, the method 400 is performed on processing logic, including hardware, firmware, software, or a combination thereof. In some implementations, the method 400 is performed on a processor executing code stored in a non-transitory computer-readable medium (e.g., a memory).

In an exemplary implementation, the device utilized to perform the techniques of method 400 may include a processor, an input sensor, and one or more other sensors. The input sensor may include a plurality of interactable elements (e.g., keys). In an exemplary implementation, the input sensor is a keyboard. The keyboard may be a virtual keyboard that is presented on a display of the device (e.g., typing on a screen of a mobile device), presented virtually on another device (e.g., a separate display device), or projected by the device on another surface (e.g., virtually displayed keyboard as viewed through an HMD). Additionally, or alternatively, the device may be a separate input sensor such as a hardware keyboard. The one or more other sensors may include accelerometers, microphones, cameras, touch sensors on a display, sensors within a hardware keyboard, and the like, as discussed herein with reference to FIGS. 1-3.

At block 402, the method 400 obtains sensor data from a first sensor. For example, the method 400 may include obtaining sensor data from a first sensor of the one or more other sensors, where the first sensor is a separate sensor from the input sensor, and the sensor data is associated with use of the input sensor by a user (e.g., typing on a keyboard).

In some implementations, the sensor data may be image data of an eye, a hand, or a head of the user. In some implementations, the sensor data includes physiological data. For the example, the physiological data may include electrocardiogram (EKG) data, electroencephalogram (EEG) data, or electrooculography (EOG) data, and the like. In some implementations, the sensor data includes other data such as motion sensor data, haptic data, location data, audio data, and the like. In some implementations, the sensor data includes ambient light data.

In some implementations, obtaining physiological data includes EEG amplitude/frequency, pupil modulation, eye gaze saccades, head movements, and the like, from which pupil response/gaze direction/movement can be determined. In some implementations, obtaining physiological data (e.g., pupillary data 40) is associated with a gaze of a user that may involve obtaining images of the eye or electrooculography signal (EOG) data from which gaze direction and/or movement can be determined. In some implementations, the physiological data includes at least one of skin temperature, respiration, photoplethysmogram (PPG), electrodermal activity (EDA), eye gaze tracking, and pupillary movement that is associated with the user. In some implementations, obtaining physiological data includes head movements of the user (e.g., obtained from an IMU or from image sensor data), such as head movement data 314.

In some implementations, obtaining sensor data includes acquiring hand pose information during use of the input sensor. For example, as illustrated in FIG. 1, the device includes one or more user-facing cameras 32, 34, for acquiring body movement data. In some implementations, for example while wearing an HMD, the device includes cameras for tracking hand movements specifically, or another camera sensor picking up hand pose. In some implementations, the hand pose information may be used to update and/or track keystroke data to store as a user profile.

In some implementations, determining the movement and/or the location and features of the head 27 of the user 25 (e.g., an edge of the eye, a nose or a nostril) are extracted by the device 10 and used in finding coarse location coordinates of the eyes 45 of the user 25, thus simplifying the determination of precise eye 45 features (e.g., position, gaze direction, etc.) and making the gaze characteristic(s) measurement and corresponding keystroke dynamics more reliable and robust. Furthermore, the device 10 may readily combine the 3D location of parts of the head 27 with gaze angle information obtained via eye part image analysis in order to identify a given on-screen object at which the user 25 is looking at any given time. In some implementations, the use of 3D mapping in conjunction with gaze tracking allows the user 25 to move his or her head 27 and eyes 45 freely while reducing or eliminating the need to actively track the head 27 using sensors or emitters on the head 27.

By tracking the eyes 45, some implementations reduce the need to re-calibrate the user 25 after the user 25 moves his or her head 27. In some implementations, the device 10 uses depth information to track the pupil's 50 movement, thereby enabling a reliable present pupil diameter to be calculated based on a single calibration of user 25. Utilizing techniques such as pupil-center-corneal reflection (PCCR), pupil tracking, and pupil shape, the device 10 may calculate the pupil diameter, as well as a gaze angle of the eye 45 from a fixed point of the head 27 and use the location information of the head 27 in order to re-calculate the gaze angle and other gaze characteristic(s) measurements. In addition to reduced recalibrations, further benefits of tracking the head 27 may include reducing the number of light projecting sources and reducing the number of cameras used to track the eye 45.

Some implementations obtain physiological data and other user information to help improve a user experience. In such processes, user preferences and privacy should be respected, as examples, by ensuring the user understands and consents to the use of user data, understands what types of user data are used, has control over the collection and use of user data and limiting distribution of user data, for example, by ensuring that user data is processed locally on the user's device. Users should have the option to opt in or out with respect to whether their user data is obtained or used or to otherwise turn on and off any features that obtain or use user information. Moreover, each user will have the ability to access and otherwise find out anything that the system has collected or determined about him or her. User data is stored securely on the user's device. User data that is used as input to a machine learning model is stored securely on the user's device, for example, to ensure the user's privacy. The user's device may have a secure storage area, e.g., a secure enclave, for securing certain user information, e.g., data from image and other sensors that is used for face identification or biometric identification. The user data associated with the user's body and/or attentive state may be stored in such a secure enclave, restricting access to the user data and restricting transmission of the user data to other devices to ensure that user data is kept securely on the user's device. User data may be prohibited from leaving the user's device and may be used only in machine learning models and other processes on the user's device.

At block 404, the method 400 assesses a characteristic associated with the use of the input sensor based on the sensor data. The use characteristic may include a keyboard use pattern (e.g., keystroke dynamics, keystroke rate, error rate, force of typing, and the like). Additionally, the use characteristics may include determining a physiological state (e.g., gaze direction, head position) or cognitive state (e.g., stressed, attentive, attentive to a particular thing, responding negatively to a keyboard error) of the user. Moreover, environmental context, displayed content, and/or user physical characteristics (e.g., motor impairments, user's anatomy, i.e., broken/missing finger, small hands, etc.), may also be analyzed characteristics associated with use of the input sensor.

In some implementations, the characteristic associated with the use of the input sensor includes a keystroke use pattern associated with the user. For example, the characteristic associated with the use of the input sensor may include keystroke dynamics, keystroke rate, error rate, force of typing, and the like. In some implementations, the characteristic associated with the use of the input sensor may be specific to the user via a profile. For example, as discussed herein, a user profile may be stored and updated in the input sensor database 358 that is specific to the user. Alternatively, in some implementations, the characteristic associated with the use of the input sensor maybe an average of any type of user (e.g., default settings), or may be an average of a user that is similar to the current user (e.g., similar height, size of hands, etc.). For example, a large-scale data collection for several people may be acquired which defines likelihood functions for clusters of similar users.

In some implementations, the characteristic associated with the use of the input sensor includes a physiological state. For example, the physiological state may include a gaze direction, a head position, and the like.

In some implementations, the characteristic associated with the use of the input sensor includes a cognitive state. For example, the cognitive state may include a state of being stressed. The cognitive state may include a state of being attentive, such as being attentive to a particular thing (e.g., focused on content being presented on the device, focused on something in the environment, etc.) The cognitive state may include a negative response associated with a keyboard error (e.g., frustration of the user may be detected based on image data of the user's head/face/eyes).

In some implementations, the characteristic associated with the use of the input sensor includes an environmental context. For example, the environment of the user may include typing on a bumpy train. Additionally, the environmental context may be a time of day, or the current ambient light. In some implementations, the characteristic associated with the use of the input sensor is based on the content displayed on the device. For example, the characteristic being analyzed may be based on the application(s) that are being used currently on the device. For example, settings for a gaming application may be different than setting for a word processing document or typing a text to another user.

In some implementations, the characteristic associated with the use of the input sensor includes physical characteristics of the user. For example, physical characteristics of the user may include detecting motor impairments of the user while he or she is typing or based on an obtained user profile. Additionally, physical characteristics of the user may include the user's anatomy, i.e., broken/missing finger, small hands, etc.

At block 406, the method 400, determines whether to provide a response based on the characteristic associated with the use of the input sensor, the response updating the input sensor with a personalized setting or providing personalized content to the user regarding input sensor use. For example, based on the obtained sensor data (e.g., keyboard data, image data of the user, physiological data, etc.), the techniques described herein can determine whether to provide a response based on the characteristic associated with the use of the input sensor (e.g., input sensor 80). For example, the techniques can update the input sensor with a personalized setting or provide personalized content (e.g., feedback notifications, autocomplete for particular text, and the like) to the user regarding input sensor use, and adjust the content corresponding to the experience. In some implementations, the feedback may guide the user to a “healthy” typing style (e.g., correct posture while typing). The keyboard personalized setting may be determined to optimize a preferred user state, for example, by repositioning virtual keys, changing the sound of a key click, changing the keyboard pressure settings, etc. Whether to respond may be based on a threshold. Whether and how to respond may be based on a likelihood function regarding user preferences (e.g., based on prior keyboards use, cognitive or motor impairments, application usage etc.) in combination with a large-scale data collection which defined likelihood functions for clusters of similar users.

In some implementations, where the input sensor is a physical keyboard, the system can track the location of the user's resting hands either from image data, or from capacitive sensors to detect whether palms are resting. In some implementations, the method 400 further includes determining to provide personalized content for the response based on the hand pose information associated with the use of the input sensor. For example, feedback may be provided (e.g., feedback notification data 357 from feedback module 356) to guide the user to a “healthy” typing style. The feedback may be a visual and/or auditory notification(s) that teach the user to adjust their hand pose and/or sitting pose while typing. The feedback may also include a notification to suggest to the user to take a break from typing and provide some options/suggestions for the user (e.g., take a walk, meditation techniques, stretching, adjust desk from sit down to a stand up position, etc.).

In some implementations, determining whether to provide the response based on the characteristic associated with the use of the input sensor includes determining to update the input sensor with the personalized setting. In some implementations, the personalized setting includes repositioning at least one interactable element of the plurality of the plurality of interactable elements. For example, as illustrated in FIG. 2C, the repositioning of the virtual keys (e.g., “QWERTY curved”) may be presented to the user, which may facilitate better typing posture and reduce the risk of carpal tunnel syndrome, or other arthritic issues for the hands of the user. In some implementations, the personalized setting includes changing an audio feedback setting of at least one interactable element of the plurality of the plurality of interactable elements. For example, changing the sound of a key click. In some implementations, the personalized setting includes changing a haptic feedback setting of at least one interactable element of the plurality of the plurality of interactable elements. For example, as discussed herein with reference to FIG. 2B, changing a haptic feedback setting of at least one interactable element may include changing the keyboard pressure settings and vibration settings (e.g., because the user was detected as typing in a loud and/or moving environment, such as on a train).

In some implementations, determining whether to provide the response based on the characteristic associated with the use of the input sensor is based on determining a likelihood function associated with preference settings of the user. For example, prior to observing a user's typing, a likelihood function could be initialized by predicting a user's preference based on relevant knowledge about the user (e.g., previous keyboards used, cognitive or motor impairments, application usage) in combination with a large-scale data collection which defined likelihood functions for clusters of similar users. In some implementations, the method 400 further includes gradually updating the input sensor with the personalized setting based on the determined likelihood function associated with preference settings of the user. For example, gradually updating the input sensor with the personalized setting surreptitiously manipulate keyboard settings subtly via gradual changes over time or via slightly larger setting changes between typing sessions. Additionally, or alternatively, the techniques described herein can provide the user with a feedback mechanism (e.g., feedback notification data 357 from feedback module 356) such as an invite/link to a training session where typing is performed under various settings.

In some implementations, providing personalized content includes providing feedback to the user regarding the assessed characteristic of the user during use of the input sensor. For example, personalized content may include an experience (e.g., a program) for raising typing awareness to a user. For example, a low impact reminder/notification could be provided to the user regarding his or her force of keystrokes compared to a threshold amount of force. In some implementations, physiological data may be tracked over time with keystroke data to predict/warn the user for a particular health assessment (e.g., carpal tunnel syndrome, arthritis, etc.).

In some implementations, the use of the input sensor includes text being displayed on the device, and providing personalized content including modifying the text based on assessing the characteristic associated with the use of the input sensor (e.g., autocomplete of text). In some implementations, positional information could be tracked (e.g., finger position on each keycap) to determine distributions of where the fingers land when typing. By analyzing the distributions of data (e.g., typing “teh” frequently), the techniques described herein can adapt the keyboard to adjust the misspelling of “teh” without needing textual context to change it. For example, the system would need the sentence to figure out the typo/context of the word “the” the user intended to type.

In some implementations, a machine training/learning may be utilized for a typing style use case to predict desirable keyboard settings (e.g., pleasing look, feel, and sound) as appropriate to context and learned user preferences, and based on the obtained sensor data. The machine learning model may use mapping to determine the user's striking of keys and to learn to make better predictions with a goal of optimization of the personal settings of the keyboard per user. In an exemplary implementation, assessing the characteristic associated with the use of the input sensor based on the sensor data includes determining an input sensor use pattern associated with the use of the input sensor for the user during a time period, and determining whether to provide the response based on the characteristic associated with the use of the input sensor includes updating the input sensor with the personalized setting from a first state to a different second state. For example, the system builds detailed knowledge about the user's response to various keyboard settings by tracking user responses. Text input data (e.g., keystroke dynamics, mouse/touchscreen/trackpad interactions, lexical content of input text, which have all been linked to mood and cognitive state) may be used to label user state, for example, relating to mood, focus, and typing fluency. Although user state may include many descriptors, it could be summarized as a single signed value where positive state is desirable. Inferred user state is stored with contextual information, including at minimum the keyboard settings profile. After logging sufficient data, the method can predict preferred keyboard settings by optimizing for positive user state, which could be done conditionally on context (e.g., time of day, application used, etc.).

In some implementations, the input sensor use pattern is classified using a machine learning technique based on the sensor data and the characteristic associated with the use of the input sensor. For example, a machine learning prediction model may be utilized. In some implementations, the machine learning technique is refined based on at least one of text input data, keystroke rate, error rate, a force of typing. (e.g., keystroke dynamics, mouse/touchscreen/trackpad interactions, lexical content of input text, which have all been linked to mood and cognitive state). In some implementations, the machine learning model is a neural network (e.g., an artificial neural network), decision tree, support vector machine, Bayesian network, or the like. These labels may be collected from the user beforehand, or from a population of people beforehand, and fine-tuned later on for individual users. Creating this labeled data may require many users going through an experience (e.g., a typing experience) where the users are entering text input based on commands (e.g., typing instructed words) and then the user is provided with different keyboard settings and randomly asked which keyboard settings they preferred once they had ample time to use the different settings. The answers to these questions can generate a label for the time prior to the question and a deep neural network or deep long short-term memory (LSTM) network might learn a combination of features specific to that user or task given those labels (e.g., sensitivity levels, illumination levels, haptic levels, layouts, etc.).

In some implementations, the method 400 further includes adjusting a presentation of content on the device based on determining to provide the response based on the characteristic associated with the use of the input sensor (e.g., feedback user interface element). For example, content may be adjusted by a content developer to improve keyboard settings for a subsequent use for the user or other users. In some implementations, the method 400 may further include adjusting content corresponding to the experience in response to determining that the cognitive state differs from a cognitive state intended for the experience (e.g., detecting that the user is frustrated).

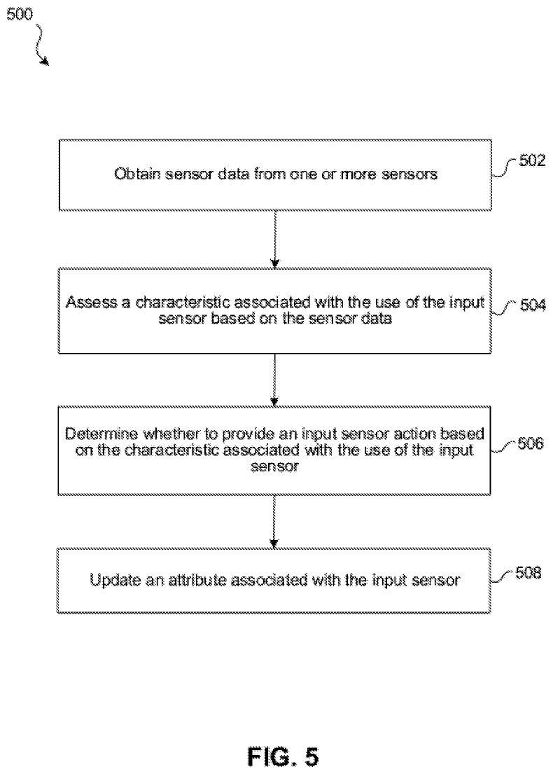

FIG. 5 is a flowchart illustrating an exemplary method 500. In some implementations, a device, such as device 10 of FIG. 1, performs the techniques of method 500 to determine whether to provide an input sensor action based on the characteristic associated with the use of the input sensor such as input sensor 80. For example, the method 500 may monitor keyboard use (including keystroke dynamics) to perform an input sensor action such as alter software (touchscreen) keyboard settings (e.g., layout, responsiveness, sounds, etc.). The processes can update the settings of the input sensor based on individual use patterns, physiological data (e.g., using gaze for predictive text), cognitive state (e.g., stressed), context of the environment (e.g., typing on a bumpy train, time, ambient light, other apps, etc.), and/or user physical characteristics (e.g., size of hand, height, proper typing stance). The input sensor can change appearance, layout/size, haptic feedback, audio-feedback, and the like. Multiple sensors may track keystroke patterns and other keyboard use characteristics (e.g., accelerometers, microphone, cameras (eye tracking or finger tracking while typing), ambient light sensors, etc.).

In some implementations, the techniques of method 500 are performed on a mobile device, desktop, laptop, HMD, or server device. In some implementations, the method 500 is performed on processing logic, including hardware, firmware, software, or a combination thereof. In some implementations, the method 500 is performed on a processor executing code stored in a non-transitory computer-readable medium (e.g., a memory).

In an exemplary implementation, the device utilized to perform the techniques of method 500 may include a processor, an input sensor, and one or more other sensors. The input sensor may include a plurality of interactable elements (e.g., keys). In an exemplary implementation, the input sensor is a keyboard. The keyboard may be a virtual keyboard that is presented on a display of the device (e.g., typing on a screen of a mobile device), presented virtually on another device (e.g., a separate display device), or projected by the device on another surface (e.g., virtually displayed keyboard as viewed through an HMD). The one or more other sensors may include accelerometers, microphones, cameras, touch sensors on a display, sensors within hardware of an external device, and the like, as discussed herein with reference to FIGS. 1-3.

At block 502, the method 500 obtains sensor data from a first sensor. For example, the method 400 may include obtaining sensor data from a first sensor of the one or more other sensors, where the first sensor is a separate sensor from the input sensor, and the sensor data is associated with use of the input sensor by a user (e.g., typing on a keyboard).

In some implementations, the sensor data may be image data of an eye, a hand, or a head of the user. In some implementations, the sensor data includes physiological data. For the example, the physiological data may include EKG data, EEG data, or EOG data, and the like. In some implementations, the sensor data includes other data such as motion sensor data, haptic data, location data, audio data, and the like. In some implementations, the sensor data includes ambient light data.

In some implementations, obtaining physiological data includes EEG amplitude/frequency, pupil modulation, eye gaze saccades, head movements, and the like, from which pupil response/gaze direction/movement can be determined. In some implementations, obtaining physiological data (e.g., pupillary data 40) is associated with a gaze of a user that may involve obtaining images of the eye or EOG data from which gaze direction and/or movement can be determined. In some implementations, the physiological data includes at least one of skin temperature, respiration, PPG, EDA, eye gaze tracking, and pupillary movement that is associated with the user. In some implementations, obtaining physiological data includes head movements of the user (e.g., obtained from an IMU or from image sensor data), such as head movement data 314.

In some implementations, obtaining sensor data includes acquiring hand pose information during use of the input sensor. For example, as illustrated in FIG. 1, the device includes one or more user-facing cameras 32, 34, for acquiring body movement data. In some implementations, for example while wearing an HMD, the device includes cameras for tracking hand movements specifically, or another camera sensor picking up hand pose. In some implementations, the hand pose information may be used to update and/or track keystroke data to store as a user profile.

At block 504, the method 500 assesses a characteristic associated with the use of the input sensor based on the sensor data. The use characteristic may include a keyboard use pattern (e.g., keystroke dynamics, keystroke rate, error rate, force of typing, and the like). Additionally, the use characteristics may include determining a physiological state (e.g., gaze direction, head position) or cognitive state (e.g., stressed, attentive, attentive to a particular thing, responding negatively to a keyboard error) of the user. Moreover, environmental context, displayed content, and/or user physical characteristics (e.g., motor impairments, user's anatomy, i.e., broken/missing finger, small hands, etc.), may also be analyzed characteristics associated with use of the input sensor.

In some implementations, the characteristic associated with the use of the input sensor includes a keystroke use pattern associated with the user. For example, the characteristic associated with the use of the input sensor may include keystroke dynamics, keystroke rate, error rate, force of typing, and the like. In some implementations, the characteristic associated with the use of the input sensor may be specific to the user via a profile. For example, as discussed herein, a user profile may be stored and updated in the input sensor database 358 that is specific to the user. Alternatively, in some implementations, the characteristic associated with the use of the input sensor maybe an average of any type of user (e.g., default settings), or may be an average of a user that is similar to the current user (e.g., similar height, size of hands, etc.). For example, a large-scale data collection for several people may be acquired which defines likelihood functions for clusters of similar users.

In some implementations, the characteristic associated with the use of the input sensor includes a physiological state. For example, the physiological state may include a gaze direction, a head position, and the like.

In some implementations, the characteristic associated with the use of the input sensor includes a cognitive state. For example, the cognitive state may include a state of being stressed. The cognitive state may include a state of being attentive, such as being attentive to a particular thing (e.g., focused on content being presented on the device, focused on something in the environment, etc.) The cognitive state may include a negative response associated with a keyboard error (e.g., frustration of the user may be detected based on image data of the user's head/face/eyes).

In some implementations, the characteristic associated with the use of the input sensor includes an environmental context. For example, the environment of the user may include typing on a bumpy train. Additionally, the environmental context may be a time of day, or the current ambient light. In some implementations, the characteristic associated with the use of the input sensor is based on content displayed on the device. For example, the characteristic being analyzed may be based on the application(s) that are being used currently on the device. For example, settings for a gaming application may be different than setting for a word processing document or typing a text to another user.

In some implementations, the characteristic associated with the use of the input sensor includes physical characteristics of the user. For example, physical characteristics of the user may include detecting motor impairments of the user while he or she is typing or based on an obtained user profile. Additionally, physical characteristics of the user may include the user's anatomy, i.e., broken/missing finger, small hands, etc.

At block 506, the method 500, determines whether to provide an input sensor action based on the characteristic associated with the use of the input sensor. For example, based on the obtained sensor data (e.g., keyboard data, image data of the user, physiological data, etc.), the techniques described herein can determine whether to provide an input sensor action based on the characteristic associated with the use of the input sensor (e.g., input sensor 80).

At block 508, the method 500, in response to determining to provide an input sensor action, updates an attribute associated with the input sensor. For example, the techniques can automatically update the input sensor layout, responsiveness, sounds. The input sensor action may include updating the input sensor to a preferred user state (or optimized state), for example, by repositioning virtual keys, changing the sound of a key click, changing the keyboard pressure settings, etc. Whether to respond may be based on a threshold. Whether and how to respond may be based on a likelihood function regarding user preferences (e.g., based on prior keyboards use, cognitive or motor impairments, application usage etc.) in combination with a large-scale data collection which defined likelihood functions for clusters of similar users.

In some implementations, determining whether to provide an input sensor action is based on the characteristic associated with the use of the input sensor includes determining to update the input sensor with the personalized setting. In some implementations, the personalized setting includes repositioning at least one interactable element of the plurality of the plurality of interactable elements. For example, as illustrated in FIG. 2C, the repositioning of the virtual keys (e.g., “QWERTY curved”) may be presented to the user, which may facilitate better typing posture and reduce the risk of carpal tunnel syndrome, or other arthritic issues for the hands of the user. In some implementations, the personalized setting includes changing an audio feedback setting of at least one interactable element of the plurality of interactable elements. For example, changing the sound of a key click. In some implementations, the personalized setting includes changing a haptic feedback setting of at least one interactable element of the plurality of interactable elements. For example, as discussed herein with reference to FIG. 2B, changing a haptic feedback setting of at least one interactable element may include changing the keyboard pressure settings and vibration settings (e.g., because the user was detected as typing in a loud and/or moving environment, such as on a train).

In some implementations, determining whether to provide the input sensor action based on the characteristic associated with the use of the input sensor is based on determining a likelihood function associated with preference settings of the user. For example, prior to observing a user's typing, a likelihood function could be initialized by predicting a user's preference based on relevant knowledge about the user (e.g., previous keyboards used, cognitive or motor impairments, application usage) in combination with a large-scale data collection which defined likelihood functions for clusters of similar users. In some implementations, the method 500 further includes gradually updating the input sensor with the personalized setting based on the determined likelihood function associated with preference settings of the user. For example, gradually updating the input sensor with the personalized setting surreptitiously manipulate keyboard settings subtly via gradual changes over time or via slightly larger settings changes between typing sessions. Additionally, or alternatively, the techniques described herein can provide the user with a feedback mechanism (e.g., feedback notification data 357 from feedback module 356) such as an invite/link to a training session where typing is performed under various settings.

In some implementations, providing personalized content includes providing feedback to the user regarding the assessed characteristic of the user during use of the input sensor. For example, personalized content may include an experience (e.g., a program) for raising typing awareness to a user. For example, a low impact reminder/notification could be provided to the user regarding his or her force of keystrokes compared to a threshold amount of force. In some implementations, physiological data may be tracked over time with keystroke data to predict/warn the user for a particular health assessment (e.g., carpal tunnel syndrome, arthritis, etc.).

In some implementations, the use of the input sensor includes text being displayed on the device, and providing personalized content includes modifying the text based on assessing the characteristic associated with the use of the input sensor (e.g., autocomplete of text). In some implementations, positional information could be tracked (e.g., finger position on each keycap) to determine distributions of where the fingers land when typing. By analyzing the distributions of data (e.g., typing “teh” frequently), the techniques described herein can adapt the keyboard to adjust the misspelling of “teh” without needing textual context to change it. For example, the system would need the sentence to figure out the typo/context of the word “the” the user intended to type.

In some implementations, a machine training/learning may be utilized for a typing style use case to predict desirable keyboard settings (e.g., pleasing look, feel, and sound) as appropriate to context and learned user preferences, and based on the obtained sensor data. The machine learning model may use mapping to determine the user's striking of keys and to learn to make better predictions with a goal of optimization of the personal settings of the keyboard per user. In an exemplary implementation, assessing the characteristic associated with the use of the input sensor based on the sensor data includes determining an input sensor use pattern associated with the use of the input sensor for the user during a time period, and determining whether to provide the input sensor action based on the characteristic associated with the use of the input sensor includes updating the input sensor with the personalized setting from a first state to a different second state. For example, the system builds detailed knowledge about the user's response to various keyboard settings by tracking user responses. Text input data (e.g., keystroke dynamics, mouse/touchscreen/trackpad interactions, lexical content of input text, which have all been linked to mood and cognitive state) may be used to label user state, for example, relating to mood, focus, and typing fluency. Although user state may include many descriptors, it could be summarized as a single signed value where positive state is desirable. Inferred user state is stored with contextual information, including at minimum the keyboard settings profile. After logging sufficient data, the method can predict preferred keyboard settings by optimizing for positive user state, which could be done conditionally on context (e.g., time of day, application used, etc.).

In some implementations, the input sensor use pattern is classified using a machine learning technique based on the sensor data and the characteristic associated with the use of the input sensor. For example, a machine learning prediction model may be utilized. In some implementations, the machine learning technique is refined based on at least one of text input data, keystroke rate, error rate, a force of typing. (e.g., keystroke dynamics, mouse/touchscreen/trackpad interactions, lexical content of input text, which have all been linked to mood and cognitive state). In some implementations, the machine learning model is a neural network (e.g., an artificial neural network), decision tree, support vector machine, Bayesian network, or the like. These labels may be collected from the user beforehand, or from a population of people beforehand, and fine-tuned later on for individual users. Creating this labeled data may require many users going through an experience (e.g., a typing experience) where the users are entering text input based on commands (e.g., typing instructed words) and then the user is provided with different keyboard settings and randomly asked which keyboard settings they preferred once they had ample time to use the different settings. The answers to these questions can generate a label for the time prior to the question and a deep neural network or deep long short-term memory (LSTM) network might learn a combination of features specific to that user or task given those labels (e.g., sensitivity levels, illumination levels, haptic levels, layouts, etc.).

In some implementations, the method 500 further includes adjusting a presentation of content on the device based on determining to provide the input sensor action based on the characteristic associated with the use of the input sensor (e.g., feedback user interface element). For example, content may be adjusted by a content developer to improve keyboard settings for a subsequent use for the user or other users. In some implementations, the method 500 may further include adjusting content corresponding to the experience in response to determining that the cognitive state differs from a cognitive state intended for the experience (e.g., detecting that the user is frustrated).

In some implementations, the techniques described herein for method 400 and method 500 may include one more of the following implementations.

In some implementations, the techniques described herein obtain physiological data (e.g., pupillary data 40, EEG amplitude/frequency data, pupil modulation, eye gaze saccades, head movements, etc.) and associated keystroke dynamics from the user based on identifying typical interactions of the user with the input sensor. For example, the techniques may determine that a variability of an eye gaze characteristic of the user correlates with an interaction with the experience. Additionally, the techniques described herein may then adjust a visual characteristic of the experience or adjust/change a sound associated with the interaction element, to enhance physiological data associated with future interactions with the experience and/or the interaction element presented within the experience. Moreover, in some implementations, changing an interaction element after the user interacts with the experience informs the physiological response of the user in subsequent interactions with the interaction element or a particular segment of the experience. For example, the user may present an anticipatory physiological response associated with the change within the interaction element (e.g., a change in typing pace of the interaction element). Thus, in some implementations, the technique identifies an intent of the user to interact with the interaction element based on an anticipatory physiological response. For example, the technique may adapt or train an instruction set by capturing or storing physiological data of the user based on the interaction of the user with the experience (e.g., typing pace), and may detect a future intention of the user to interact with the experience by identifying a physiological response of the user in anticipation of the presentation of the enhanced/updated interaction element.

In some implementations, the techniques described herein assess the physiological data with respect to a keystroke dynamic. In some implementations, the system may determine whether the user's gaze may be moving in a way that corresponds to typing. In some implementations, the system may determine whether the user's gaze movement corresponds to an average typing pace and/or the user's specific typing pace. In some implementations, the pupillary response is a direction of the pupillary response, a velocity of the pupillary response, or pupillary fixations (e.g., derived from eye gaze dynamics and saccade characteristics). In some implementations, the pupillary response is derived from a saccade characteristic (e.g., micro saccades and saccadic intrusions). In some implementations, saccade characteristics are a separate attribute or type of physiological data than the pupillary response, such that the method 400 may alternatively, at block 404, determine a saccade characteristic other than a pupillary response during the use of the input sensor. For example, saccade characteristics may include measuring micro saccades and/or saccadic intrusions.

In some implementations, the techniques described herein can determine a context of the experience based on sensor data of the environment. For example, determining a context may involve using computer vision to generate a scene understanding of the visual and/or auditory attributes of the environment—where is the user, what is the user doing, what objects are nearby. Additionally, a scene understanding of the content presented to the user could be generated that includes the visual and/or auditory attributes of what the user was watching.

In some implementations, different contexts of the content presented and the environment are analyzed to determine where the user is, what the user is doing, what objects or people are nearby in the environment or within the content, what the user did earlier (e.g., meditated in the morning). Additionally, context analysis may include image analysis (semantic segmentation), audio analysis (jarring sounds), location sensors (where user is), motion sensors (fast moving vehicle), and even access other user data (e.g., a user's calendar). In an exemplary implementation, the techniques described herein may further include determining the context of the experience by generating a scene understanding of the environment based on the sensor data of the environment, the scene understanding including visual or auditory attributes of the environment and determining the context of the experience based on the scene understanding of the environment.

In some implementations, the sensor data includes image data, and generating the scene understanding is based at least on performing semantic segmentation of the image data and detecting one or more objects within the environment based on the semantic segmentation. In some implementations, determining the context of the experience includes determining an activity of the user based on the scene understanding of the environment. In some implementations, the sensor data includes location data of the user, and determining the context of the experience includes determining a location of the user within the environment based on the location data.

In some implementations, determining the context of the experience includes determining an activity of the user based on a user's schedule. For example, the system may access a user's calendar to determine if a particular event is occurring when the input sensor and associated actions are assessed. For example, different applications may include different interaction elements to be provided to the user to select via his or her pupillary response (eye gaze characteristics) and keystroke dynamics.

In some implementations, customization of the experience could be controlled by the user. For example, a user could select the experience he or she desires, such as he or she can choose the ambience, background scene, music, etc. Additionally, the user could alter the threshold of updating the input sensor settings. For example, the user can customize the sensitivity of triggering of suggested changes to the input sensor based on prior experience of a session. For example, a user may desire to not have as many notifications and allow some mind wandering (e.g., eye position deviations) before a suggested change to the input sensor is triggered. Thus, particular experiences can be customized on triggering a threshold when higher criteria are met.

In some implementations, an estimator or statistical learning method is used to better understand or make predictions about the physiological data (e.g., pupillary data characteristics, head movements, etc.) and associated keystroke dynamics. For example, statistics for pupillary data may be estimated by sampling a dataset with replacement data (e.g., a bootstrap method).

In some implementations, a machine learning model (e.g., a trained neural network) is applied to identify patterns in physiological data and the associated keystroke dynamics of the user, including identification of physiological responses to presentation of content (e.g., content 20 of FIG. 1) during a particular experience (e.g., education, meditation, instructional, etc.). Moreover, the machine learning model may be used to match the patterns with learned patterns corresponding to indications of interest or intent of the user 25 to interact with the interaction element, such as typing selectable text selections (e.g., ordering from a menu). In some implementations, the techniques described herein may learn patterns specific to the particular user 25. For example, the techniques may learn from determining that a peak pattern represents an indication of interest or intent of the user 25 in response to a particular visual characteristic within the content and use this information to subsequently identify a similar peak pattern as another indication of interest or intent of the user 25 (e.g., a pattern in typing pace). Such learning can take into account the user's relative interactions with multiple visual characteristics, in order to further adjust the content and enhance the user's physiological response to the experience and the presented content (e.g., focusing on particular areas of content versus other distracting areas). In some implementations, the machine learning model is a neural network (e.g., an artificial neural network), decision tree, support vector machine, Bayesian network, or the like.

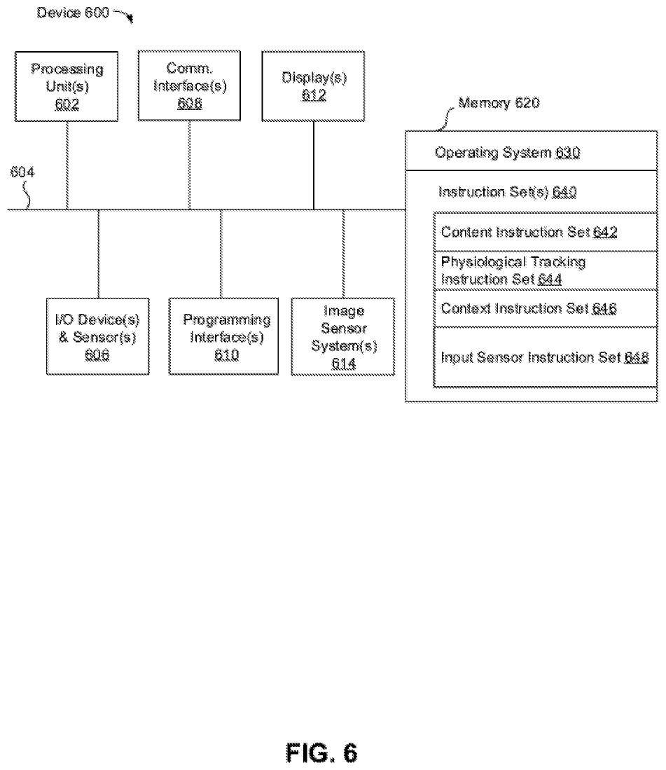

FIG. 6 is a block diagram of an example device 600. Device 600 illustrates an exemplary device configuration for device 10. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 10 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 120, and/or the like type interface), one or more programming (e.g., I/O) interfaces 610, one or more displays 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 612 are configured to present a view of a physical environment or a graphical environment to the user. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 612 correspond to diffractive, reflective, polarized, holographic, etc. and waveguide displays. In one example, the device 10 includes a single display. In another example, the device 10 includes a display for each eye of the user.

In some implementations, the one or more image sensor systems 614 are configured to obtain image data that corresponds to at least a portion of the physical environment 5. For example, the one or more image sensor systems 614 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 include a content instruction set 642, a physiological tracking instruction set 644, a context instruction set 646, and input sensor instruction set 648. The instruction set(s) 640 may be embodied a single software executable or multiple software executables.

In some implementations, the content instruction set 642 is executable by the processing unit(s) 602 to provide and/or track content for display on a device. The content instruction set 642 may be configured to monitor and track the content over time (e.g., during an experience such as an education session) and/or to identify change events that occur within the content. In some implementations, the content instruction set 642 may be configured to inject change events into content (e.g., feedback mechanisms) using one or more of the techniques discussed herein or as otherwise may be appropriate. To these ends, in various implementations, the instruction set includes instructions and/or logic therefor, and heuristics and metadata therefor.

In some implementations, the physiological tracking instruction set 644 is executable by the processing unit(s) 602 to track a user's physiological attributes (e.g., EEG amplitude/frequency, pupil modulation, eye gaze saccades, heart rate, EDA data, etc.) using one or more of the techniques discussed herein or as otherwise may be appropriate. To these ends, in various implementations, the instruction set includes instructions and/or logic therefor, and heuristics and metadata therefor.

In some implementations, the context instruction set 646 is executable by the processing unit(s) 602 to determine a context of the experience and/or the environment (e.g., create a scene understanding to determine the objects or people in the content or in the environment, where the user is, what the user is watching, etc.) using one or more of the techniques discussed herein (e.g., object detection, facial recognition, etc.) or as otherwise may be appropriate. To these ends, in various implementations, the instruction includes instructions and/or logic therefor, and heuristics and metadata therefor.

In some implementations, the input sensor instruction set 648 is executable by the processing unit(s) 602 to assess the senor data, physiological data, and/or context data, and the like, and determine whether to provide a response or an input sensor action based on a characteristic associated with the use of the input sensor using one or more of the techniques discussed herein or as otherwise may be appropriate. To these ends, in various implementations, the instruction set includes instructions and/or logic therefor, and heuristics and metadata therefor.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

According to some implementations, the electronic device 10 generates and present an extended reality (XR) environment to one or more users during a playback session (e.g., while typing on a virtual keyboard while wearing an HMD). In contrast to a physical environment that people can sense and/or interact with without aid of electronic devices, an XR environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon typing the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a device comprising a processor, an input sensor, and one or more other sensors, wherein the input sensor comprises a plurality of interactable elements:
obtaining sensor data from a first sensor of the one or more other sensors, wherein the first sensor is separate from the plurality of interactable elements of the input sensor, and the sensor data is associated with use of the input sensor by a user;
assessing a characteristic associated with the use of the input sensor based on the sensor data; and
determining whether to provide a response based on the characteristic associated with the use of the input sensor, the response updating the input sensor with a personalized setting or providing personalized content to the user regarding input sensor use.

2. The method of claim 1, wherein the characteristic associated with the use of the input sensor comprises a keystroke use pattern associated with the user.

3. The method of claim 1, wherein the characteristic associated with the use of the input sensor comprises a physiological state.

4. The method of claim 1, wherein the characteristic associated with the use of the input sensor comprises a cognitive state.

5. The method of claim 1, wherein the characteristic associated with the use of the input sensor comprises an environmental context.

6. The method of claim 1, wherein the characteristic associated with the use of the input sensor is based on content displayed on the device.

7. The method of claim 1, wherein the characteristic associated with the use of the input sensor comprises physical characteristics of the user.

8. The method of claim 1, wherein obtaining sensor data comprises acquiring hand pose information during use of the input sensor.

9. The method of claim 8, further comprising:
determining to provide personalized content for the response based on the hand pose information associated with the use of the input sensor.

10. The method of claim 1, wherein determining whether to provide the response based on the characteristic associated with the use of the input sensor comprises determining to update the input sensor with the personalized setting.

11. The method of claim 10, wherein the personalized setting comprises repositioning at least one interactable element of the plurality of the plurality of interactable elements.

12. The method of claim 10, wherein the personalized setting comprises changing an audio feedback setting of at least one interactable element of the plurality of the plurality of interactable elements.

13. The method of claim 10, wherein the personalized setting comprises changing a haptic feedback setting of at least one interactable element of the plurality of the plurality of interactable elements.

14. The method of claim 1, wherein determining whether to provide the response based on the characteristic associated with the use of the input sensor is based on determining a likelihood function associated with preference settings of the user.

15. The method of claim 14, further comprising:
gradually updating the input sensor with the personalized setting based on the determined likelihood function associated with preference settings of the user.

16. The method of claim 1, wherein providing personalized content comprises providing feedback to the user regarding the assessed characteristic of the user during use of the input sensor.

17. The method of claim 1, wherein the use of the input sensor comprises text being displayed on the device, and providing personalized content comprises modifying the text based on assessing the characteristic associated with the use of the input sensor.

18. The method of claim 1, wherein:
assessing the characteristic associated with the use of the input sensor based on the sensor data comprises determining an input sensor use pattern associated with the use of the input sensor for the user during a time period, and
determining whether to provide the response based on the characteristic associated with the use of the input sensor comprises updating the input sensor with the personalized setting from a first state to a different second state.

19. The method of claim 18, wherein the input sensor use pattern is classified using a machine learning technique based on the sensor data and the characteristic associated with the use of the input sensor, wherein the machine learning technique is refined based on at least one of text input data, keystroke rate, error rate, and a force of typing.

20. The method of claim 1, further comprising:
adjusting a presentation of content on the device based on determining to provide the response based on the characteristic associated with the use of the input sensor.

21. The method of claim 1, wherein the sensor data comprises image data of an eye, a hand, or a head of the user.

22. The method of claim 1, wherein the sensor data comprises motion sensor data, haptic data, location data, or audio data.

23. The method of claim 1, wherein the sensor data comprises physiological data, wherein the physiological data comprises electrocardiogram (EKG) data, electroencephalogram (EEG) data, or electrooculography (EOG) data.

24. A device comprising:
an input sensor comprising a plurality of interactable elements;
one or more other sensors;
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining sensor data from a first sensor of the one or more other sensors, wherein the first sensor is separate from the plurality of interactable elements of the input sensor, and the sensor data is associated with use of the input sensor by a user;
assessing a characteristic associated with the use of the input sensor based on the sensor data; and
determining whether to provide a response based on the characteristic associated with the use of the input sensor, the response updating the input sensor with a personalized setting or providing personalized content to the user regarding input sensor use.

25. A non-transitory computer-readable storage medium, storing program instructions executable on a device to perform operations comprising:
obtaining sensor data from a first sensor of one or more other sensors, wherein the first sensor is separate from a plurality of interactable elements of an input sensor, and the sensor data is associated with use of the input sensor by a user;
assessing a characteristic associated with the use of the input sensor based on the sensor data; and
determining whether to provide a response based on the characteristic associated with the use of the input sensor, the response updating the input sensor with a personalized setting or providing personalized content to the user regarding input sensor use.
